(19) United States
(12) Patent Application Publication
(10) Pub. No.: US 2003/0228558 A1
(43) Pub. Date: Dec. 11, 2003

(54) Method of training brokers in a multi-level marketing business

(76) Inventors: William Dennis Bloom, Dallas, TX (US); Daniel Flynn Bloom, Plano, TX (US); John Asa Hammack JR., Plano, TX (US); Barry Friedman, Southlake, TX (US); Debra Wimberley Aaron, Plano, TX (US); Dale Irwin Brooks, Fort Lauderdale, FL (US); Mark Douglas Dixon, Flower Mound, TX (US); Brent Allen Goodwin, Frisco, TX (US); Carlos Fernando Gueits JR., Miami Springs, FL (US); James Edward Hardin, McKinney, TX (US); Mark Lewis Jarvis, Houston, TX (US); Eugene Marvin Krank JR., Petersburg, VA (US); Michael Arthur Lancto, Jacksonville, FL (US); John Michael McDonald, Dallas, TX (US); Bradley Scott Murray, Pilot Point, TX (US); Linda Gaye Rowden, Plano, TX (US); John Alexander Southerland, Jonesboro, GA (US); William Kirby Wright, Alpharetta, GA (US); Todd William Wilson, The Colony, TX (US); Terrence Van Wilson, Chester, VA (US)

Correspondence Address: HOWISON & ARNOTT, L.L.P, P.O. BOX 741715, DALLAS, TX, 75374-1715, US

(21) Appl. No.: 10/166,820

(22) Filed: Jun. 11, 2002

(51) Int. Cl. G09B 19/18

(52) U.S. Cl. 434/107; 434/219; 434/362; 434/365

(57) ABSTRACT

A method of training brokers in a multi-level marketing business to make sales of a product and to recruit new brokers includes the steps of presenting materials to train brokers on order form procedures. The order form procedures include collecting identification information and payment information. The method also includes presenting materials to train brokers on recruiting form procedures. The recruiting form procedures include collecting identification information, payment information, and the selection of sales packages. The method also includes presenting materials to train brokers on sales procedures. The sales procedures include the steps of listing prospects, approach prospects, provide a sales presentation, enroll members and brokers, and continually repeat the sales procedure.

### TECHNICAL FIELD OF THE INVENTION

The invention relates to a method of training brokers in a multi-level marketing business and structuring commissions including training.

### BACKGROUND OF THE INVENTION

Multi-level marketing, also known as network marketing, is a method of sales promotion in which a commission is paid to the broker responsible for making the sale, to the broker responsible for recruiting and training the broker who is making the sale as well, and possibly to brokers further up the recruiting and training chain. One of the most difficult elements of making this kind of system profitable is the training of the new brokers. Because the income of the system depends on the success of each broker in making sales and recruiting new brokers, it is critical to the success of a multi-level marketing business that each broker receive sufficient training to adequately perform the necessary sales and recruiting processes.

### SUMMARY OF THE INVENTION

The present invention disclosed and claimed herein, in one aspect thereof, comprises a method of training brokers in a multi-level marketing business to make sales of a product and to recruit new brokers includes the steps of presenting materials to train brokers on order form procedures. The order form procedures include collecting identification information and payment information. The method also includes presenting materials to train brokers on recruiting form procedures. The recruiting form procedures include collecting identification information, payment information, and the selection of sales packages. The method also includes presenting materials to train brokers on sales procedures. The sales procedures include the steps of listing prospects, approach prospects, provide a sales presentation, enroll members and brokers, and continually repeat the sales procedure.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a multi-level marketing business.

FIG. 2 illustrates another aspect of a multi-level marketing business.

FIG. 3 illustrates a flowchart of the process by which a broker recruits or sells products to prospective customers.

FIG. 4 illustrates an outline of the initial training provided to a new broker.

FIG. 5 illustrates the content of initial training program;

FIG. 6 illustrates the sales form;

FIG. 7 illustrates the process of filling out the broker form;

FIG. 8 illustrates the commissions structure process;

FIG. 9 illustrates a simplified illustration of an Internet communications system;

FIG. 10 illustrates the online sales process;

FIG. 11 illustrates the online recruiting process;

FIG. 12 illustrates the communication services offered to brokers

FIG. 13 illustrates the printed marketing materials;

FIG. 14 illustrates an outline the commissions; and

FIG. 15 illustrates an outline of the bonuses.

### DETAILED DESCRIPTION OF THE INVENTION

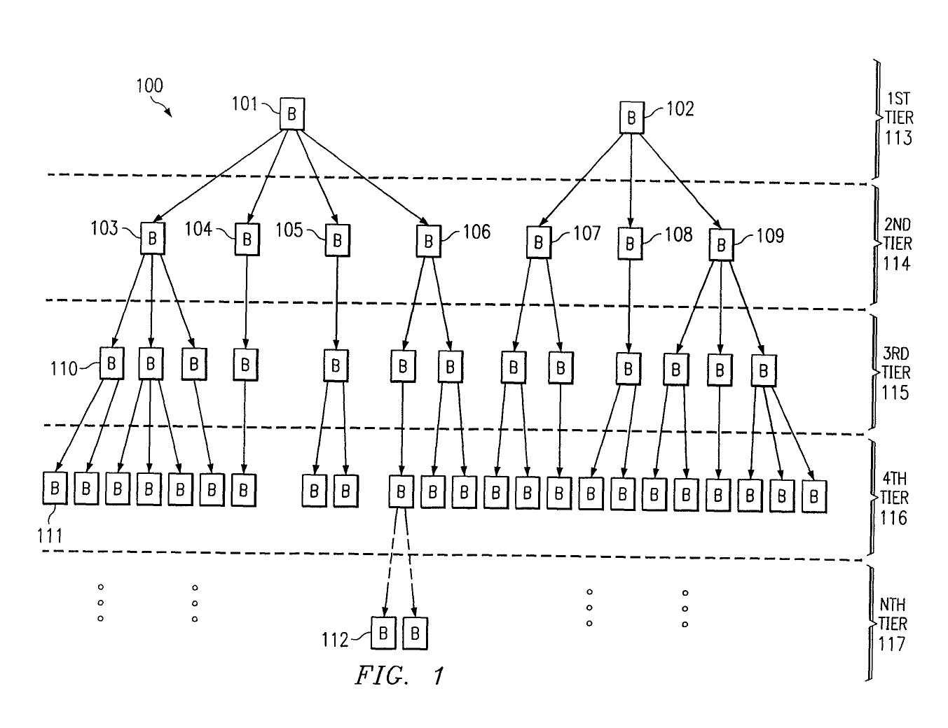

FIG. 1 illustrates a multi-level marketing business 100. In a multilevel marketing business, brokers are recruited to sell products. The product offered for purchase may be a good, service or membership in a group. The product may be sold for a one-time purchase price or a periodic subscription fee. The product may be delivered immediately or ordered for later delivery. In the case of a membership sale, the purchasers information is collected for submission to the provider.

First tier brokers 113 recruit second tier brokers 114 to sell a product and recruit third tier brokers 115. In the example shown, a first broker 101 has at this point in time recruited four second tier brokers 103, 104, 105, and 106. A second broker 102 has recruited three second tier brokers, 107, 108, and 109. Brokers 103 through 29 form a second tier of brokers 114.

When the first tier broker 101 makes a sale of the product, broker 101 receives a commission on the sale. Similarly, when second tier broker 104 makes a sale, the broker 104 receives a commission on the sale. In addition, because broker 101 recruited broker 104, when broker 104 makes a sale, broker 101 also receives a commission on the sale.

For example, if broker 104 made a $20.00 sale, broker 104 may receive a $5.00 commission on the sale and broker 101 may receive a $2.00 commission on broker 104's sale.

The specifics of the commission structure may vary depending on the organization and economics of the provider and market. For example, sales and/or recruiting thresholds may be required before a first tier broker is eligible to receive commissions on sales made by second tier brokers.

The second tier brokers 114 may also recruit third tier brokers 115. In the present example, broker 110 was recruited by broker 103. Brokers of both the first tier 113 and second tier 114 may receive commissions based on sales made by brokers of the third tier 115. For example, a sale made by broker 110 could result in commissions being paid to broker 110, broker 103 and broker 101.

In like fashion, the third tier brokers 115 recruit fourth tier brokers 116. In the present example, broker 111 was recruited by broker 110. Sales by broker 111 could result in commission paid to broker 111, broker 110, broker 103 and broker 101.

This commission structure may continues through as many tiers as can be recruited down to the nth tier 117 with broker 112.

Because each broker has an incentive to make sales as well as recruit brokers who in turn have an incentive to further recruit brokers and make sales, the sales of the product may quickly escalate.

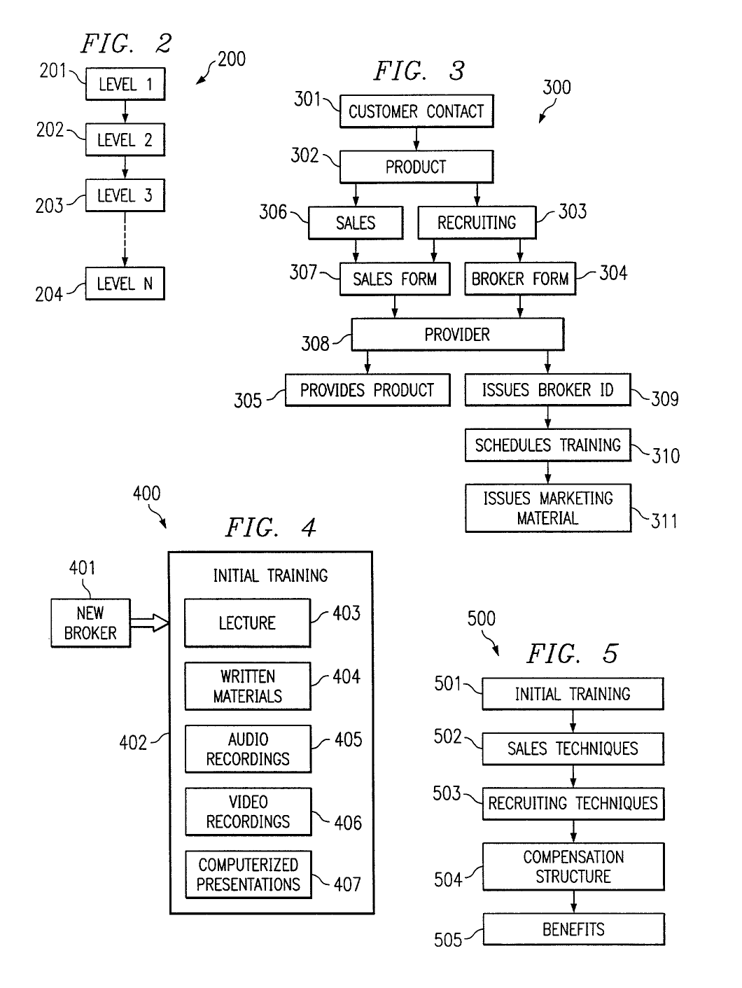

FIG. 2 illustrates another aspect of a multi-level marketing business 200. Step 201 represents a first level broker who receives commissions on his own sales. When a first level broker 201 has recruited a specified number of first level brokers, the first level broker becomes a second level broker 202. When a specified number of the first level brokers who were recruited by the second level broker 202 become second level brokers, the second level broker 202 becomes a third level broker 203. This process continues as the brokers recruited by the broker are promoted through the ranks. Eventually a broker may reach some specified upper level of broker, a nth level broker 204.

FIG. 3 is a flowchart 300 of the process by which a broker recruits or sells products to prospective customers. The process begins with a customer contact 301. The customer contact 301 may involve telephone calls, e-mail contact or face-to-face meetings. During the customer contact, the broker then introduces the product 302 to the customer. After the product 302 has been introduced to the customer, the broker proceeds to query the customer's interest in the product and the opportunity to sell the product.

First, the broker may proceed to sell the product to the prospective customer 306. The sales process may involve explaining the advantages of the product, including the quality, price and other features of the product. If the customer agrees to buy the product, a sales form is filled out 307. When the information in the sales form is collected, the sales form is transmitted to the provider of the product 308 for processing. The provider provides the product to the customer in exchange for payment 305.

The broker may also proceed to recruit the customer as a broker 303. The broker may explain both the advantages of the product and the advantages that accrue to someone affiliated with the provider and authorized to sell the product. If the customer agrees to become a broker, a broker form 304 is sent to the provider 308. The provider enters the information on the broker form into a broker database and issues a broker ID number to the new broker 309. Training is then scheduled for the new broker 310 and printed marketing materials are issued to the new broker 311.

When the recruited broker has agreed to buy the product as well, a sales form 307 is filled out and sent to the provider 308. The provider provides the product to the new broker in exchange for payment 305. Payment for the product may be included in the broker fees.

FIG. 4 shows an outline of the initial training provided to a new broker 400. When a new broker is recruited 401, the new broker is provided with initial training 402. The initial training 402 may include lectures by other brokers, provider representatives, experts and other teaching professionals 403. The initial training 402 may include written materials 404. The written materials 404 may include forms, brochures, textbooks and other documents. The initial training 402 may include audio recordings 405 and video recordings 406 which explain the product, the sales process, the recruiting process, the compensation systems, benefits and other relevant information. As well, the initial training 402 may include computerized presentations 407, such as Power Point presentations.

FIG. 5 outlines the content of initial training program 500. The initial training 501 may begin with discussions about sales techniques 502. A discussion of recruiting techniques 503 may be included to assist brokers in techniques of recruiting new brokers. A compensation structure is discussed in step 504 and the benefits to brokers are discussed in step 505.

The sales training program may include steps for implementing a repeatable sales procedure. In accordance with the preferred embodiment, the sales procedure steps are simple and based on the premise of never creating a stressful or unpleasant experiences for either the broker or the potential customer.

The sales procedure begins with the step of making lists of potential prospects, both for customers of the product as well as recruits. An initial set of lists is compiled for contact within the first two weeks. It is generally expected that one out of every four contacts contacted will result in either a sale or recruitment.

These lists may divide the potential prospects into groups divided according to their relationship with the broker. A first list may be developed including people who are very close to the broker, individuals who can be contacted with little explanation. These are the people who will be contacted immediately, who can be expected to listen to what the broker has to say without being judgmental.

A second list may be developed including people who are well-acquainted with the broker, individuals who can be expected to respond receptively to contact by the broker. A third list may be developed including people who are acquainted with the broker, individuals who know the broker. A fourth list may be developed including people less familiar with the broker but who may be expected to benefit from the product or compensation.

The sales procedure may include guidance on approach, the manner of making initial contact with the prospects, including instruction on approaches that can be used to makes sales and recruit new brokers. The approach is the method by which contact is made with a prospect and the course of by which business is conducted. Approaches may be prepared tracks or scripts to work with. Brokers may also be instructed on ways to deal with both positive and negative responses by the potential customers and recruits.

The sales procedure may include training in making a sales presentation. The sales presentation may include multi-media presentation materials, including video, slide shows and printed material such as brochures.

The training program may be incorporated in the multi-level marketing program to provide a further source of income to the provider, to enhance the abilities of the brokers and incorporated in the compensation system by making eligibility for certain bonuses depend on successful completion of the training program.

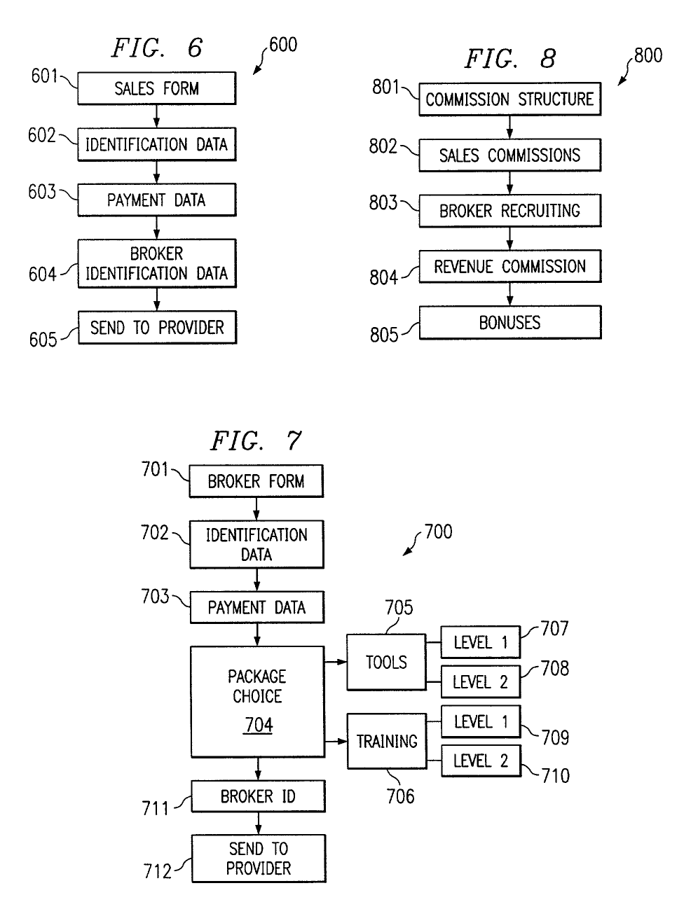

FIG. 6 outlines the sales form 601. The sales form 601 may include identification data 602, for identifying the customer who is purchasing the product. The identification data 602 may include the name of the customer, the mailing address of the customer, the telephone number of the customer, the email address of the customer, the social security number of the customer and other identification information. Payment data 603 is collected to identify a method of payment that will used to pay for the product and details of the payment method. In accordance with the preferred embodiment, the payment data may authorize charges to a credit card or authorize a bank draft. Broker identification data 604 is provided by the broker making the sale, so that the broker is identified to the provider so that the broker may collect commission on the sale. When the sales form has been properly filled out, it is sent to the provider at step 605.

FIG. 7 outlines the process of filling out the broker form 700. When a new broker has been recruited, a broker form 701 is filled out. The broker form 701 is filled out by the new broker and the recruiting broker. In step 702, identification data is collected from the new broker. The identification data may include the new broker's address, the new broker's telephone number the new broker's social security number, the new broker's email address and other identification information necessary to identify the new broker. In step 703, payment data is collected. The payment data 703 selects a method for payment of the broker's fees. In accordance with the preferred embodiment, the payment data will include authorizations for a credit card or an authorization of a bank draft. Step 704 allows the broker to choose between various sales support packages. Packages regarding sales tools are depicted in step 705. In the preferred embodiment, there will be multiple levels of tool packages shown as level 1 707 and level 2 708. A level 1 tool package 707 may include only the necessary tools to make the sales. A level 2 tool package 708 may include additional material including specialized telephone numbers, fax numbers, web-sites, brochures and other sales literature. Training packages are shown in step 706. In accordance with the preferred embodiment, multiple levels of training packages 706 are shown including a level 1 training package 709 and a level 2 training package 710. The level 1 training package 709 may include a simple instruction regarding the process of making sales. Level 2 training packages 710 may include further instruction on sales and recruiting techniques. In step 711, the broker ID of the recruiting broker is provided so that the recruiting broker receives proper credit for recruiting the new broker. When the broker form is completed, the broker form is sent to the provider in step 712.

FIG. 8 outlines the commissions structure process 800. The commissions structure 801 may be broken down into commissions on sales 802, broker recruiting commissions 803, recruiting revenue commission 804, and bonuses 805.

FIG. 9 shows a simplified illustration of an Internet communications system 900. The Internet communications system 900 may include one or more computers 901. Generally, the computer 901 will be an standard home computer or laptop computer. Those having ordinary skill will recognize that other computing devices may be utilized. Computer 901 is connected to the Internet 902 using standard methods including telephone lines and broadband communication systems. A provider server 903 is similarly connected to the Internet 902. Using the Internet communications system 900, information can be sent from any number of computers 901 to the provider server 903. As well, information may be sent from the provider server 903 to customers and brokers throughout the world via the Internet at computers 901.

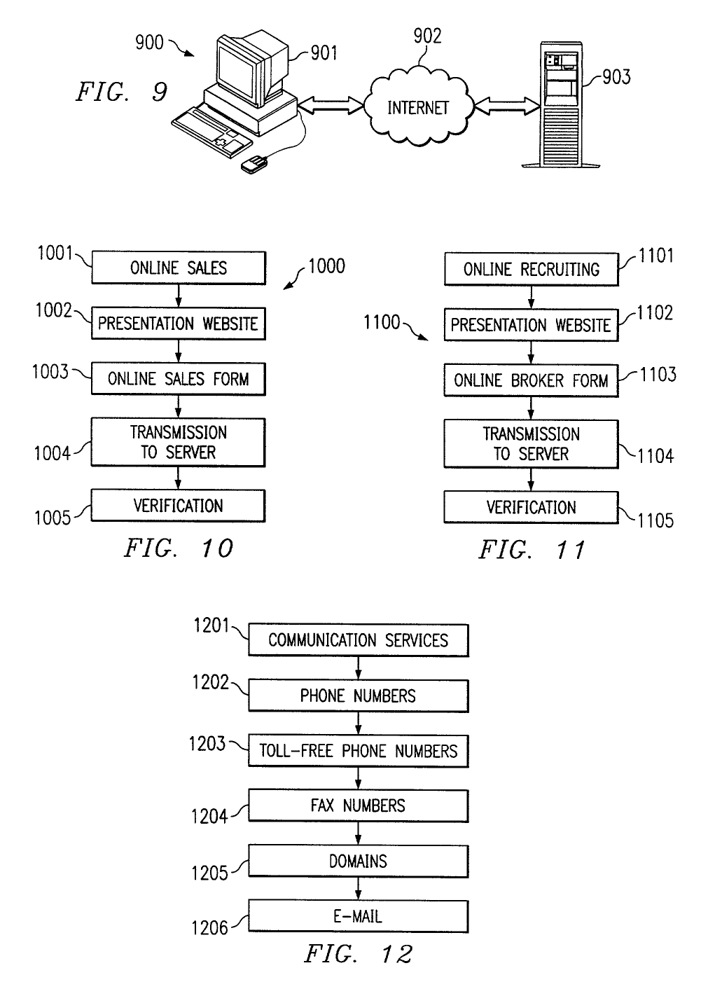

FIG. 10 depicts the online sales process 1000. An online sale 101 is initiated at a computer 901. A presentation website 1002 may be displayed on the monitor of computer 901. The presentation website 1002 may include information on the product, the provider and the broker making the sale. The presentation website 1002 may be linked to an online sales form 1003. The online sales form 1003 is a website designed to allow customers to enter the information collected in the sales form shown in FIG. 6 by entering information at computer 901. When the online sales form 1003 is completed, it is transmitted through the Internet 902 to the server 903 in step 1004. The provider server 903 checks the information provided on the online sales form and if the online sales form is completed correctly, a verification message 1005 is sent via the Internet 902 to the customer and/or broker at computer 901.

FIG. 11 depicts the online recruiting process 1100. When online recruiting is initiated 1101, a presentation website 1102 is displayed at computer 901. The presentation website may provide information about the product, the provider, the recruiting broker, compensation, benefits and other relevant information. The presentation website 1102 is linked to an online broker form 1103. The online broker form 1103 is a website designed to allow a new broker to enter the information collected in the broker form depicted in FIG. 7. The new broker enters the information using computer 901 to the online broker form. When the online broker form 1103 is completed, it is transmitted from the computer 901 through the Internet 902 to the provider server 903. When the provider server 903 receives the online broker form, the online broker form is checked for completeness and accuracy. If the online broker form is properly completed, a verification message 1105 is sent via the Internet 902 to the new broker and recruiting broker at computer 901.

FIG. 12 illustrates the communication services 1201 offered to brokers. The communication services 1201 may include customized telephone number 1202. The telephone numbers 1202 may include numbers that are easy to remember. The brokers may be provided with toll free telephone numbers 1203 to allow customers to make phone calls to the broker from any location without cost. Fax numbers may be provided to brokers to allow brokers to receive faxes from customers, brokers and the provider. The brokers may be offered domain names and website services to allow them to provide online sales and recruiting pages 1205. As well, the brokers may be offered e-mail addresses 1206.

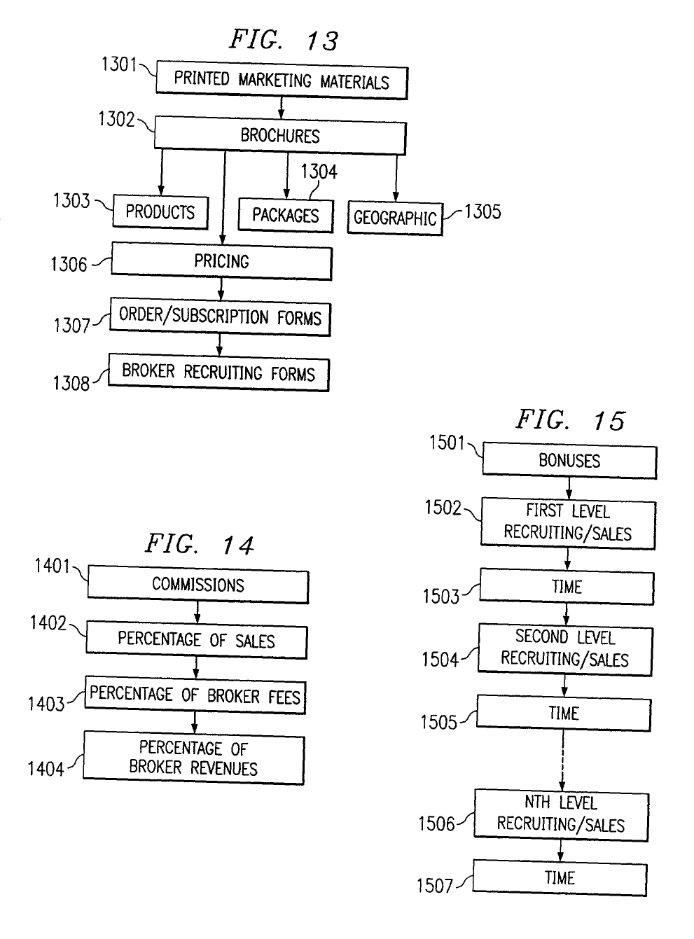

FIG. 13 illustrates the printed marketing materials 1301 that maybe offered to a broker. The printed marketed materials 1301 may include brochures 1302. The brochures 1302 may describe the product 1303, packages of products offered by the provider 1304, and information specialized to geographic areas 1305. Brokers may be offered printed marketing materials 1301 which include pricing information 1306. The brokers may be provided with order subscription forms 1307. The brokers may be provided with broker recruiting forms 1308.

FIG. 14 outlines the commissions 1401. The commissions 1401 may include a percentage of the sales of the product 1402. As well, the commissions may include a percentage of the broker's fees collected from brokers recruited by the broker 1403. A percentage of broker revenues 1404 may also be paid as a commission to each broker. The percentage of broker revenues 1404 will include a percentage of revenues of brokers recruited by the broker.

FIG. 15 depicts an outline of the bonuses 1501. Bonuses may be paid for the first level of recruiting and sales achieved by the broker 1502. Bonuses may also be paid for accomplishing the first level recruiting and sales within a specified time 1503. Further bonuses may be awarded for second levels of recruiting and sales 1504. As well, additional bonuses may be awarded for achieving second level recruiting and sales within a specified time 1505. The bonus process may continue to any level shown as nth level recruiting and sales 1506 and achieving the nth level recruiting and sales within a specified time 1507.

Although the preferred embodiment has been described in detail, it should be understood that various changes, substitutions and alterations can be made therein without departing from the spirit and scope of the invention as defined by the appended claims.

What is claimed is:

1. A method of training brokers in a multi-level marketing business to make sales of a product and to recruit new brokers comprising the steps of:
presenting materials to train brokers on order form procedures wherein said order form procedures include collecting identification information and payment information;
presenting materials to train brokers on recruiting form procedures wherein said recruiting form procedures include collecting identification information, payment information, and the selection of sales packages; and
presenting materials to train brokers on sales procedures wherein said sales procedures include the steps of listing prospects, approach prospects, provide a sales presentation, enroll members and brokers, and continually repeat the sales procedure.

2. The method of claim 1 wherein said presentations of materials includes the use of printed materials.

3. The method of claim 1, wherein said presentations of materials include the use of audio recordings.

4. The method of claim 1, wherein said presentations of materials include the use of video recordings.

5. The method of claim 1, wherein said presentations of materials include the use of computer presentations.

6. The method of claim 1, wherein said order form procedures include collecting identification information and payment information include using a website to collect the information.

7. The method of claim 1, wherein said recruiting form procedures include collecting identification information, payment information and selection of sales packages include using a website.
